(19) United States
(12) Patent Application Publication
(10) Pub. No.: US 2004/0062845 A1
(43) Pub. Date: Apr. 1, 2004

(54) Beverage emulsion stabilizer

(76) Inventors: Gregory R. Krawczyk, Princeton Junction, NJ (US); Jose Amundarain, Burlington, NJ (US); Holly P. Bertrand, Chesterfiled Twp., NJ (US); Maurice Gerard Lynch, Waterloo (BE)

Correspondence Address: FMC Corporation, Patent Administrator, 1735 Market Street, Philadelphia, PA, 19103, US

(21) Appl. No.: 10/433,107

(22) PCT Filed: Nov. 30, 2001
(86) PCT No.: PCT/US01/44799

(51) Int. Cl. A23L 1/05

(52) U.S. Cl. 426/573; 426/578; 426/590

(57) ABSTRACT

A composition useful as a stabilizer for beverage emulsions and a method for its preparation are disclosed. The stabilizer composition contains co-processed modified starch and propylene glycol alginate. The ratio by weight of modified starch % to about 95%. The co-processed stabilizer composition is prepared by forming an aqueous dispersion of the modified starch and the propylene glycol alginate and drying the aqueous dispersion. Beverage emulsions comprising the stabilizer, beverage products comprising the beverage emulsions, and the methods for their preparation are also disclosed.

### FIELD OF THE INVENTION

This invention relates to beverage products. In particular, this invention relates to beverage products in which a beverage emulsion is stabilized with a co-processed propylene glycol alginate/modified starch composition and to processes for preparing the co-processed propylene glycol alginate/modified starch composition, the beverage emulsion, and the beverage product.

### BACKGROUND OF THE INVENTION

Beverage products desirably have a cloudy or opaque appearance. The cloudy or opaque appearance of these beverage products is typically achieved by incorporating a beverage emulsion. Beverage emulsions can be either flavor emulsions, which provide the beverage product with both flavor and cloudiness, or cloud emulsions, which provide cloudiness but essentially no flavor. Both types of beverage emulsions comprise a discontinuous oil phase dispersed in a continuous aqueous phase, i.e., they are “oil-in-water” emulsions. Typically, the oil phase is uniformly dispersed in the continuous aqueous phase in the form of fine droplets that give the beverage product its cloudy or opaque appearance and, if the emulsion is a flavor emulsion, provide a uniform distribution of the flavor.

Beverage emulsions are thermodynamically unstable two-phase systems that have a tendency to separate into two immiscible liquids. Because the oil is the dispersed phase, it exists as droplets that tend to separate, or “flocculate” by aggregating to form clumps. In the absence of weighting agents, the oil phase, which is less dense than the aqueous phase, can separate and rise to the top of the beverage container. This phenomenon is referred to as “creaming” and can manifest itself as an unsightly ring inside the neck of the bottle (a condition commonly referred to as “ringing”) or as powdery “floc” on the shoulder of the bottle. Conversely, the oil phase can become attached to colloidal particles or other materials heavier than the aqueous phase, in which case the oil phase will settle to the bottom of the container. This condition is usually referred to as “sedimentation” because the cloud appears as sediment on the bottom of the bottle. Sedimentation may also occur if the oil phase is over weighted with weighting agent.

In the preparation of beverage products, the beverage emulsion, which has a pH of about 3.5 and which, in the case of a flavor emulsion, comprises about 10% by weight flavor oil, is prepared first. About 2% by weight or less of the beverage emulsion is added to an aqueous solution comprising about 55-60% by weight solids, primarily sweetener, such as sugar, and food grade acid, such as citric acid, to form a syrup, which is at about pH 2.5. The syrup is then diluted with about five parts of water, or with carbonated water if a carbonated beverage product is being prepared, to form the beverage product, which typically has a pH of about 3.0. The beverage emulsion must be stable by itself, in the syrup, and in the beverage product. Typically, the beverage emulsion must be stable for about one year before dilution and for about six months in the beverage product.

To enhance the stability of beverage emulsions a thickener or emulsion stabilizer is added to the aqueous phase. Gum arabic is typically the thickener of choice in flavor emulsions. However, gum arabic is a natural exudate gum produced by Acacia senegal, a shrub best suited to arid regions of Africa. Thus, its availability and price are subject to fluctuations in the political and climatic conditions in this region of the world.

Various potential replacements for gum arabic as a thickener in beverage emulsions have been proposed. Jackman, U.S. Pat. No. 4,163,807, proposes the combination of xanthan gum and sodium carboxymethyl cellulose. Wolf, U.S. Pat. No. 5,342,643, proposes an emulsion system comprising a native protein/-alkylene glycol alginate complex stabilizer. Clark, U.S. Pat. No. 5,376,396, proposes a beverage stabilization system that comprises gellan gum and carboxymethyl cellulose. Goldner, U.S. Pat. No. 5,508,059, proposes the use of lecucena gum. Drake, U.S. Pat. No. 5,624,698, and Montezions, U.S. Pat. No. 5,919,512, propose the use of xanthan gum.

Thickeners can adversely affect the flavor and mouthfeel of the beverage product, especially if relatively large quantities of thickener are required. When included in the beverage products at higher levels, some thickeners can additionally destabilize the beverage emulsion. In addition, carbohydrate gums are relatively expensive.

Thus, a need exists for a stabilizer for beverage emulsions that does not adversely affect the beverage flavor, is not relatively expensive, and is not subject to wide variations in availability and price.

### SUMMARY OF THE INVENTION

In one aspect, the invention is a co-processed composition useful as a stabilizer for beverage emulsions. The composition comprises co-processed modified starch and propylene glycol alginate, in which:

a) the ratio by weight of modified starch to propylene glycol alginate is about 60:40 to about 95:5; and

b) the propylene glycol alginate has a degree of esterification of about 40% to about 95%.

The modified starch is preferably modified waxy maize starch. Preferably, the propylene glycol alginate has a molecular weight, as defined by viscosity of a 1% by weight aqueous solution measured at 20° C., of about 1 to 500 cps.

In other aspects, the invention is a method for preparing the emulsion stabilizer and a method for preparing a beverage emulsion comprising the emulsion stabilizer. In yet other aspects, the invention is a beverage emulsion and a beverage product comprising the emulsion stabilizer.

### DETAILED DESCRIPTION OF THE INVENTION

### Beverage Emulsions

Beverage emulsions are oil-in-water emulsions made up of a continuous aqueous phase and a discontinuous oil phase. Although they are prepared as concentrates, they are consumed in highly diluted form. The emulsion may provide flavor, color, and cloudy appearance to the beverage, or just a cloudy appearance. The preparation and composition of beverage emulsions is discussed in “Beverage Emulsions,” by C. H. Tan, in Food Emulsions, 3d Ed, S. E. Friberg and K. Larsson, Eds., Dekker, New York, 1997, pp. 491-534.

The oil component is an important ingredient of a beverage emulsion. This component provides flavor emulsions with flavor and cloudiness and cloud emulsions with cloudiness only. The oil phase of a flavor emulsion comprises flavor oils and one or more weighting agents. The oil phase of a cloud emulsion comprises flavorless oils and, typically, one or more weighting agents.

Flavor emulsions comprise one or more suitable flavor oils. Suitable flavors include: fruit flavors, such as guava, kiwi, peach, mango, papaya, pineapple, banana, strawberry, raspberry, blueberry, orange, grapefruit, tangerine, lemon, lime, lemon-lime, etc.; cola flavors; tea flavors; coffee flavors; chocolate flavors; dairy flavors; root beer and birch beer flavors; etc. Root beer and birch beer flavors, for example, typically comprise methyl salicylate (wintergreen oil, sweet birch oil). In citrus-flavored beverage products the flavor oil typically contains several citrus oils of different types so that a well-balanced flavor is produced. Citrus oils contain more than 90% by weight mono-terpenes and a smaller amount of sesqui-terpenes. Both are carriers of the oxygenated terpenoids, sp cifically the alcohols, aldehydes, ketones, acids, and esters, that are responsible for the characteristic aroma and flavor profile of the oil.

Cloud emulsions comprise a clouding agent. Because the terpenes possess little intrinsic odor or flavor, they are often used as the oil component of cloud emulsions (clouding agent). Organoleptically neutral vegetable oils and/or hydrogenated vegetable oils, such as those derived from soybean, corn, safflower, sunflower, cottonseed, canola, rapeseed, coconut, and palm oil, may also be used as clouding agents. Pigments, such as titanium dioxide, may also be used as clouding agent.

To enhance flavor, the flavor oil may also comprise a “folded” flavor oil, a concentrated flavor oil obtained by high vacuum distillation. This process removes much of the mono-terpene hydrocarbon d-limonene while retaining the flavor components. When folded oils are used, less oil is required to produce the desired flavor and/or fragrance.

It is difficult to form stable emulsions with flavor oils because their specific gravities are lower than that of the aqueous phase. Citrus oils typically have a specific gravity in the range of 0.845 to 0.890. However, the specific gravity of a 10 to 12% by weight sugar solution is about 1.038 to 1.046. Consequently, weighting agents, or density adjusting agents, are added to flavor oils to increase their density. For cloud emulsions, the oil emulsion contains flavorless oils and weighting agents.

Weighting agents are flavorless, oil-soluble materials that have specific gravities greater than those of the flavor oils and which are miscible with the flavor oils. Although brominated vegetable oil has been used as a weighting agent, its use has been restricted or eliminated in many places in the world. Commonly used weighting agents are now ester gum, damar gum, and sucrose acetate iso-butyrate (SAIB).

Ester gum is produced by esterification of pale wood rosin with food grade glycerol. Wood rosin, a solid resinous material found in the oleoresin of pine trees, contains about 90% by weight resin acids, primarily abietic acid and pimeric acid, and about 10% by weight non-acidic neutral components. Ester gum is prepared by esterification of the wood rosin with glycerol, which produces a mixture of mono-, di-, and triglycerides. After removal of the excess glycerine by vacuum distillation and steam sparging, the wood rosin typically has a specific gravity of about 1.08 at 25° C. Currently, ester gum is approved by the United States and a number of other countries as a food additive.

Damar gum refers to a group of water-insoluble natural exudates from shrubs of the Genus Dammar, especially the Caesalpinaceae and Dipterocarpacae families, which are indigenous to Malaysia, Indonesia, and the East Indies. It is highly soluble in essential oils and is typically used as a weighting agent in cloud emulsions. Damar gum typically has a specific gravity of about 1.04 to 1.08 at 20° C.

Sucrose acetate iso-butyrate (SAIB) is a mixture of sucrose esters containing about 2 mol of acetate and 6 mol of iso-butyrate per mol of sucrose, primarily 6,6′-diacetyl-2,3,4,1′,3′,4′-hexa-iso-butyryl sucrose. It is produced by esterification of sucrose with acetic anhydride. Sucrose acetate iso-butyrate is a tasteless, odorless, and colorless viscous liquid with a specific gravity of about 1.146.

Because beverage emulsions are thermodynamically unstable two-phase systems that have a tendency to separate into two immiscible liquids, an emulsion stabilizer or thickener is added to prevent separation. The emulsion stabilizer of the invention is a co-processed composition comprising propylene glycol alginate and modified starch. In one aspect, the stabilizer comprises at least 80% by weight of the co-processed composition. In another aspect, the stabilizer comprises at least 85% by weight of the co-processed composition. In yet another aspect, the stabilizer comprises at least 90% by weight of the co-processed composition. In still yet another aspect, the stabilizer consists essentially of the co-processed composition.

Co-processing is required. A simple mixture or blend of the ingredients is not sufficient to produce the functional properties of the co-processed composition.

The term “co-processing” as used herein refers to the process of forming a uniform or essentially uniform aqueous dispersion or solution of the propylene glycol alginate and the modified starch, followed by drying to recover the co-processed PGA/starch composition. The solution may conveniently be formed by dissolving each of the components in water. Drying may be accomplished by well-known methods such as, for example, spray drying, freeze drying, air drying, pulse combustion drying, drum or roller drying, or bulk co-drying using a fluid bed dryer or some other suitable dryer. Spray drying is preferred. The co-processed PGA/starch composition may also be prepared by extrusion.

Propylene glycol alginate is a derivative of algin (alginic acid), a hydrophilic, colloidal carbohydrate acid derived from brown seaweed. Alginic acid is a polyuronic acid made up of two uronic acids: D-mannuronic acid and L-guluronic acid. The ratio of mannuronic acid and guluronic acid varies with factors such as seaweed species, plant age, and seasonal variations. Alginic acid in the form of mixed water insoluble salts, in which the principal cation is calcium, is found in the fronds and stems of seaweeds of the class Phaeophyceae, examples of which are Fucus vesiculosus, Fucus spiralis, Ascophyllum nodosum, Macrocystis pyrifera, Alaria esculenta, Laminaria longicruris, Laminaria digitata, Laminaria saccharina, and Laminaria cloustoni.

Methods for the recovery of water-insoluble alginic acid and its water-soluble salts, especially sodium alginate, are well known. They are described, for example, in Green, U.S. Pat. No. 2,036,934, and Le Gloahec, U.S. Patent U.S. Pat. No. 2,128,551.

Alginic acid is substantially insoluble in water. It forms water-soluble salts with alkali metals, magnesium, ammonium, lower amines, and certain other organic bases. These salts form viscous aqueous solutions. The salts are stable in alkaline media, but are converted to alginic acid when the pH is lowered below about pH 4. In addition, water-insoluble calcium alginate is formed if any calcium is present in the medium.

To stabilize alginate to acidic media and to media that contain calcium, alginate is reacted with an alkylene oxide, such as ethylene oxide or propylene oxide, to form a glycol alginate, which is water-soluble and compatible with acidic media and calcium-containing media. The glycol is bonded to the alginate through the carboxyl groups. Glycol alginates, especially propylene glycol alginate, have improved acid stability over unsubstituted alginic acids and their salts, and are more resistant to precipitation by calcium and other polyvalent metal ions.

Typically, alginate is reacted with propylene oxide to form propylene glycol alginate (PGA). Preparation of propylene glycol alginate is disclosed in Strong, U.S. Pat. No. 3,948,881, Pettitt, U.S. Pat. No. 3,772,266, and Steiner, U.S. Pat. No. 2,426,125. Preferably, the propylene glycol alginate has a degree of esterification of about 40% to about 95%, more preferably about 70% to 95%.

Commercial “propylene glycol alginate” may comprise other materials, typically impurities produced in the process of manufacture. For example, commercial propylene glycol alginate may comprise up to about 9% by weight propylene glycol. As used herein, “propylene glycol alginate” includes materials either with or without impurities that are normally produced in the manufacturing process.

Mixtures of propylene glycol alginates of different molecular weights may also be used to effect a greater degree of stability. A mixture of a high viscosity propylene glycol alginate and a low viscosity propylene glycol alginate may be used to provide greater emulsion stability to the beverage product without masking taste.

Propylene glycol alginates provide a range of viscosities for the solutions to which they are added, depending on the type and concentration used. When a single propylene glycol alginate is used, the propylene glycol alginate typically has a molecular weight, as defined by viscosity of a 1% by weight aqueous solution measured at 20° C., of about 1 to 500 cps, preferably about 3 to 60 cps, more preferably about 3 to 20 cps, and most preferably 3 to 5 cps. When a mixture of propylene glycol alginates is used, the viscosity of a 1% by weight aqueous solution of the mixture measured at 20° C., is typically about 1 to 500 cps, preferably about 3 to 60 cps, more preferably about 3 to 20 cps, and most preferably 3 to 5 cps. Viscosity is measured using a Brookfield viscometer.

Modified starch refers to a group of specially designed starch derivatives with balanced lipophilic and hydrophilic properties. Although “modified starch” generally refers to starch that has undergone some chemical modification, as used herein modified starch refers to starch modified by reaction with a cyclic anhydride, especially a cyclic anhydride that contains a substituent group comprising 5 to 18 carbon atoms, preferably 1-octenylsuccinic anhydride (“OSAN-starch,” sometimes called “lipophilic starch”). The approximate amount of substitution is reported to be about 2% to 3%. Modified starch and processes for its preparation are disclosed in Caldwell, U.S. Pat. No. 2,661,349.

The starch may, if desired, be “acid-thinned,” preferably before chemical modification. Acid-thinned starch is prepared by degradation of the starch molecule to produce a starch with a lower molecular weight and viscosity than the original starch. Acid-thinned starches are typically white in color and have a bland flavor. Starches in wide range of viscosities can be obtained by a controlled hydrolysis of raw starch.

The modified starch is preferably prepared from waxy maize starch, which is produced by a type of corn plant known as waxy maize. Waxy maize starch, which is clear and non-gelling, has distinctive properties that make it different from ordinary corn and potato starches. Although corn starch, potato starch, and waxy maize starch are each polymers of D-glucose, waxy maize starch contains about 93% to 100% of the branched-chain polymer amylopectin. In contrast, corn starch contains about 27% straight-chain amylose molecules in addition to amylopectin, and potato starch contains about 22% straight-chain amylose molecules.

Amylopectin has a highly branched, tree-like configuration composed of linear chains connected by α-1,6-linkages. The branch points are believed to occur at intervals of about one every 20 to 30 glucose residues. The total amylopectin molecule is composed of several hundred branches, and molecular weights are thought to be in the millions. The molecule has a globular shape.

The ratio by weight of modified starch to propylene glycol alginate in the co-processed stabilizer composition may preferably be about 60:40 to about 95:5, more preferably 75:25 to 90:10, still more preferably 80:20 to 90:10. Typically, the ratio by weight of co-processed stabilizer composition to oil phase in the beverage emulsion is about 1:2 to about 1:1. Minor amounts of water, up to about 10% by weight, may also be present in the co-processed stabilizer composition. Before dilution with syrup, the beverage emulsion typically comprises about 3% to 12% by weight, more typically about 5 to 10% by weight co-processed stabilizer composition, even more typically about 6 to 8% by weight co-processed stabilizer composition. Before dilution with syrup, the beverage emulsion typically comprises about 5% to 15% by weight, more typically about 7% by weight to about 12% by weight, even more typically about 10% by weight, oil phase.

Water is the major component of beverage emulsions. In most beverage emulsions the water content is 60 to 70% by weight, and can be as high as 85% by weight in certain formulations. The water should be treated to remove colloidal and suspended material, and any undesirable taste, odor, mineral salts, and microorganisms. Preferably, the water has a maximum alkalinity of 50 mg of calcium carbonate per liter for beverage emulsions. For beverage products, preferably the water has a maximum alkalinity of 50 mg of calcium carbonate per liter for cola drinks and 100 mg of calcium carbonate per liter for other beverage products.

Typically, acid is added to beverage emulsions to bring the pH to below about 4.5 and to control the growth of microorganisms. Citric acid is commonly used, but other edible food grade acids, such as malic, adipic, fumaric, and lactic acid can be used as replacements for citric acid. Food grade phosphoric acid is also commonly used to provide acidity, especially in cola beverages.

Preservatives, such as potassium sorbate and sodium benzoate, can be added. Typically about 400 ppm to about 1000 ppm, more typically about 650 ppm to about 750 ppm, of preservative is present in the final beverage product. Phosphates and polyphosphates may also be used as preservatives.

Coloring agents may be added to beverage emulsions. FD&C dyes, such as FD&C Yellow Dye 6 and FD&C Red Dye 40, and natural coloring agents, such as α-carotene, β-carotene, and marigold extracts are typically used. The coloring agent and flavor oil are typically matched to produce a particular impression (i.e., lime-flavored beverage products are green; orange-flavored beverage products are orange; strawberry-flavored beverage products are red; etc.). The amount added will depend on the color desired for final beverage product. Typically, dyes are not used with cloud emulsions, but pigments such as titanium dioxide may be added to provide opacity. Supplemental amounts of vitamins and minerals, such as Vitamin A and provitamins thereof, Vitamins C, D, E, etc., may also be added if they are chemically and physically compatible with the other components of the beverage emulsion, the syrup, and the beverage.

### Preparation of Beverage Emulsions

Beverage emulsions may be prepared by well-known methods. Although the procedure must be tailored to the desired emulsion, a three-step procedure is generally used. In the first step, the aqueous phase and the oil phase are prepared separately. To prepare the aqueous phase, the preservative, acid, coloring agent, and co-processed stabilizer composition are dissolved in water. To prepare the oil phase, the weighting agent, if pres nt, is added to the flavor oil for a flavor emulsion, or to the unflavored oil for a cloud emulsion.

In the second and third steps, the emulsion is formed from the separate oil and aqueous phases in a two-step process. The oil phase and the aqueous phase are mixed to form a crude emulsion, known as a pre-mix using, for example, a high-speed mixer, colloid mill, homomixer, hydroshear, or similar type of mixer. In the pre-mix, the oil droplets are all typically less than 20 μm.

The pre-mix is then homogenized to reduce the oil droplets to fine particles. The pre-mix is pumped through a homogenization valve at high pressure, which converts the oil droplets to fine particles. Single-stage or, preferably, two-stage homogenizers may be used. Although the pressure settings vary with the composition of the emulsion, the first stage is typically about 2,000 psig to 5,000 psig (about 140 to 350 kg/cm²), and the second stage is typically about 500 psig (about 35 kg/cm²). To obtain a uniform particle size, the emulsion is generally passed through the homogenizer at least twice. Although particles with diameters in the range of 0.1 to 3.0 μm are suitable, all the particles are preferably less than 2.0 μm and, more preferably, less than 1.0 μ/m. Beverage emulsions typically comprise about 65% to 85% by weight, more typically about 60% to 70% by weight, of water; about 5% to 15% by weight, more typically about 7% to about 12% by weight, even more typically about 10% by weight, of the oil phase; and about 3% to 12% by weight, more typically about 5% to 10% by weight, even more typically about 6% to about 8% by weight, of the co-processed stabilizer composition.

### Beverage Product Preparation

The beverage emulsions can be used to prepare beverage products using standard beverage formulating techniques. Beverage products include carbonated beverage products, such as colas and carbonated fruit-flavored and citrus-flavored beverage products, and uncarbonated beverage products, such as uncarbonated citrus-flavored and fruit-flavored beverage products. The preparation of beverage products and the materials used therein are well known to those skilled in the art and have been described in numerous patents and publications, such as, Nakel, U.S. Pat. No. 4,737,375; Wolf, U.S. Pat. No. 5,342,643; Calderas, U.S. Pat. No. 5,431,940; Drake, U.S. Pat. No. 5,624,698; Pflaumer, U.S. Pat. No. 5,641,532; and Montezions, U.S. Pat. No. 5,919,512, each of which are incorporated herein by reference. These techniques, when appropriately modified can be used to prepare carbonated beverage products, especially flavored carbonated beverage products. Diet beverage products containing noncaloric and artificial sweeteners, or mixtures of artificial and natural sweeteners, can also be prepared by appropriate modification.

First, a syrup is formed. Typically, the syrup comprises about 0.5% by weight to about 2.0% by weight of the beverage emulsion. The syrup comprises a sweetener, preferably a carbohydrate sweetener, in an amount sufficient to provide the desired flavor and texture. The carbohydrate sweetener is preferably a mono- or disaccharide, such as maltose, lactose, galactose, sucrose (“sugar”), glucose, fructose, an invert sugar, or a mixture thereof.

In one process, the beverage emulsion is added to an aqueous solution comprising about 55-60% by weight solids, primarily sweetener, typically a carbohydrate sweetener such as sugar, and food grade acid, such as citric acid, to form the syrup. The syrup is then diluted with water to form the final beverage product. The volume ratio of water to syrup is from about 3:1 to 8:1, typically about 5:1. To make a carbonated beverage, carbonated water can be used for the dilution, or carbon dioxide can be introduced after dilution.

The beverage emulsion typically comprises from about 0.05% by weight to about 0.7% by weight, preferably about 0.1% by weight to about 0.5% by weight of the beverage product. Carbohydrate sweeteners such as sugar, when present, typically comprise from about 0.1% to about 20%, more preferably from about 6% to about 14%, by weight, of the beverage products. Optional artificial or noncaloric sweeteners that may be used in place of, or in combination with, carbohydrate sweeteners include, for example, saccharin, cyclamates, acetosulfam, acetosulfame K (potassium acetosulfame), sucralose, L-aspartyl-L-phenylalanine low r alkyl est r sweeteners (e.g., aspartame).

Non-carbonated fruit-flavored beverage products may comprise 0.1 to 40%, preferably 1 to 20%, and more preferably 2 to 10%, and most preferably 3 to 6% juice (weight percentage based on single strength 2°-16° Brix fruit juice). The juice may be any citrus juice, non-citrus fruit juice, or mixture thereof, which is known for use in non-carbonated beverage products, such as apple, cranberry, grape, cherry, strawberry, orange, lemon, lime, tangerine, grapefruit, pineapple, coconut, etc. Non-fruit juices, such as vegetable or botanical juices, such as tomato, lettuce, celery, carrot, beet, etc, can also be used. Non-carbonated fruit-flavored beverage products typically have a pH of from about 2.5 to about 4.5, preferably from about 2.7 to about 4.0.

Tea, coffee, and chocolate solids also can be used. When tea solids are used, the non-carbonated beverage product typically comprises preferably about 0.02% by weight to about 0.25% by weight, more preferably about 0.07% by weight to about 0.15% by weight, of tea solids. Tea solids are extracted from tea materials including those materials obtained from the genus Camellia including C. sinensis and C. assaimica. Dairy-based beverage products have a pH of about 3.5 to 6.0, typically about 4.5 to 6.0.

The advantageous properties of this invention can be observed by reference to the following examples, which illustrate but do not limit the invention.

### EXAMPLES

Glossary

| | |
|---|---|
| BEV-202 | Gum Arabic (TIC Gums Inc, Belcamp, MD |
| | USA) |
| C*EmCap-Instant 126N1 | Stabilized and acid-thinned instant waxy maize |
| | starch containing about 6% by weight moisture |
| | (Cerestar, Hammond, IN, USA) |
| C*EmCap-Instant 12633 | Stabilized and acid-thinned instant waxy maize |
| | starch containing about 6% by weight moisture |
| | (Cerestar, Hammond, IN, USA) |
| Duck Loid SLF-3 | Propylene glycol alginate; degree of |
| | esterification, 92.5%; loss on drying 8.9%; |
| | viscosity of a 1% aqueous solution at 20° C., |
| | 3.4 mP · s; pH of a 1% aqueous solution at |
| | 20° C., 4.3 (Kibun Food Chemifa Co, |
| | Chiba, Japan) |
| Ester Gum 8BG | Purified glycerol ester of wood rosin (Hercules, |
| | Inc, Wilmington, DE USA) |
| PURITY ® Gum 1773 | Stabilized waxy maize starch containing about |
| | 7% moisture (National Starch and Chemical |
| | Co, Bridgewater, NJ USA) |

### Example 1

This example discloses preparation of a co-processed PGA/starch composition. PURITY® Gum 1773 waxy maize starch (267.3 g) was added to preheated (70° C.) deionized water (2,675 g) while mixing with an overhead mixer to maintain a vortex. After 30 min of mixing, Duck Loid SLF-3 propylene glycol alginate (57.5 g) was added to the water-starch mixture, and the mixture mixed for an additional 30 min. The mixture was homogenized at 2500 psi (176 Kg/cm²) using a Manton-Gaulin homogenizer 15MR-8TA. The viscosity immediately before spray drying was 1250 cps, measured with a Brookfield viscometer using #6 spindle at 20 rpm (30 sec reading).

The mixture was spray dried on a three foot (about 0.91 m) Bowen spray dryer. The inlet dryer temperature was 200° C. and the outlet temperature was 100° C. The final product was spherical in form with a moisture content of 7.8% by weight. The product was sieved through a 60 mesh screen.

### Example 2

This example shows that a co-processed PGA/modified starch stabilizer composition produces a flavor emulsion and a beverage product with better storage stability than a beverage product that contains PGA and modified starch that has not been co-processed.

a. Preparation of a Flavor Oil/Weighting Agent Mixture

A flavor oil/weighting agent mixture was prepared by mixing 540 g of Cold. Pressed Orange Oil (Florida Chemical, Winter Haven Fla. USA) (specific gravity at 25° C., 0.842-0.846) and 540 g of five-fold Folded Orange Oil (Florida Chemical). (specific gravity at 25° C., 0.860-0.870) to which a weighting agent of Ester Gum 8BG synthetic resin (920 g) was added with sufficient agitation and mixing time to fully solubilize the gum and produce a uniform mixture. The density of the mixture was about 0.975 g/cm².

b. Preparation of the Flavor Emulsion

The following stabilizers were evaluated in beverage stabilizer emulsions: BEV-202 Gum Arabic; Duck Loid SLF-3 propylene glycol alginate (PGA); PURITY® Gum 1773 starch; blends of propylene glycol alginate with starch; and the co-processed PGA/starch composition prepared in Example 1.

The flavor emulsions in Table I were prepared by dissolving sodium benzoate into room temperature filtered water while mixing on a LIGHTNIN'® mixer. The desired stabilizer was then added to the mixture with continued stirring until fully dissolved. If necessary, the mixture was heated. Citric acid and FD&C Yellow Dye 6 were pre-blended and then incorporated into the mixture with agitation. The covered mixture was left undisturbed overnight to allow the foam to dissipate. The flavor oil/weighting agent mixture was added slowly to the mixture while stirring. The dispersion was then homogenized with recirculation for two to four passes using 2500 psi (176 Kg/cm²) in the first stage and 500 psi (35 Kg/cm²) in the second stage of a Manton-Gaulin homogenizer 15MR-8TA. The resulting flavor oil emulsion was transferred to a glass container for storage. The particle size was measured using a Horiba model LA910 particle size analyzer. The PGA alone gave the lowest mean particle size and the narrowest particle size range while the co-processed PGA/starch gave the largest mean particle size.

TABLE I
Flavor Emulsions^{a}

| Ingredient | 2a | 2b | 2c | 2d | 2e | 2f^{b} | 2g |
|---|---|---|---|---|---|---|---|
| Water | 301 | 343 | 339 | 317 | 330 | 328 | 329 |
| Sodium benzoate | 0.4 | 0.4 | 0.4 | 0.4 | 0.4 | 0.4 | 0.4 |
| Gum arabic | 56 | — | — | — | — | — | — |
| PGA^{c} | — | 14 | 18 | — | 3 | 4.8 | — |
| Starch | — | — | — | 40 | 24 | 24 | — |
| Example 1^{d} | — | — | — | — | — | — | 28 |
| Citric acid | 0.8 | 0.8 | 0.8 | 0.8 | 0.8 | 0.8 | 0.8 |
| Yellow dye 6 | 1.75 | 1.75 | 1.75 | 1.75 | 1.75 | 1.75 | 1.75 |
| Flavor oil blend | 40 | 40 | 40 | 40 | 40 | 40 | 40 |
| Particle size (μ): | | | | | | | |
| median | 0.33 | 0.27 | 0.25 | 0.34 | 0.34 | 0.36 | 1.64 |
| mean | 0.35 | 0.28 | 0.26 | 0.47 | 0.53 | 1.53 | 3.13 |

^{a}Amounts given in g.
^{b}PGA and starch were dry blended before addition.
^{c}Duck Loid SLF-3.
^{d}The co-processed PGA/starch produced in Example 1.

c. Flavor Emulsion Storage Stability

Shelf-life performance at room temperature can be approximated by elevated temperature storage. Storage conditions of one week at 40° C. are estimated to be roughly equivalent to one month at room temperature.

Storage stability of the flavor emulsion prepared in step b was measured by placing about 25 g into small capped vials, which were stored at 40° C. The contents of the vials were examined each week up to 12 weeks to determine whether any visible separation of the emulsion occurred. The emulsion samples 2b and 2c, containing PGA alone, separated within the first two weeks; the higher level (sample 2c) broke within the first week and the lower level (sample 2b) broke within the second week. The emulsion samples 2e and 2f, using simple mixture of both starch and PGA, partially separated within the first 4 weeks. The gum arabic stabilized emulsion (sample 2a) separated between 8 and 12 weeks. The emulsion stabilized with starch alone (2d) and the co-processed PGA/starch stabilized emulsion (2 g) were stable for the full twelve weeks.

After storage of the emulsions at 40° C. for one and two weeks, respectively, a portion of the flavor emulsion was converted to the beverage syrup and then to the beverage product (as described below) to verify the room temperature stability of the beverage. After five months of storage at room temperature, the gum arabic, the starch, and the co-processed PGA/starch containing beverage products were the only beverage products with no neck ring formation.

d. Preparation and Storage Stability of Syrup and Beverage Products

A master batch of syrup was prepared by adding 8,835 g of sugar to a large container and then adding 6,037 g of filtered room temperature water in portions while mixing with a LIGHTNIN'® mixer to dissolve the sugar. Sodium benzoate (15.5 g) and potassium sorbate (7.75 g) were separately dissolved in a small volume of water and then added sequentially to the sugar syrup. Citric acid (387.5 g) was added to the syrup and the syrup mixed overnight.

Syrup was prepared by adding 1.44 wt % of the flavor oil emulsion to 98.6 wt % of the sugar syrup while mixing. The beverage product was prepared by adding five parts of filtered water to one part of the beverage syrup.

For commercial consideration, the beverage product should have a shelf-life at room temperature of three months in a plastic container and six months in a glass container. The appearance of the beverage product should remain uniformly “cloudy.” There should be no “ring” formation at the neck and no settling or precipitate at the bottom of the beverage product.

The syrups and beverage products prepared using the flavor emulsions with a higher level of PGA alone developed a neck ring overnight. The storage stability of syrups and beverage products prepared with emulsions containing the lower use level of PGA alone broke within the first week. Beverage products and syrups containing emulsions prepared with the starch and PGA blends were stable for the first two weeks but began to form a ring in the third week of room temperature storage. The beverage syrups and beverage products with the flavor oil emulsion stabilized using starch alone, gum arabic and the co-processed PGA/starch composition remained stable through the five months of room temperature storage evaluation.

A flavor evaluation panel tasted the beverage products after three months room temperature storage. The sample with gum arabic had a sharp distinct orange profile. The sample with starch alone had a mild, somewhat masked, flavor intensity. The sample containing the PGA/starch co-processed stabilizer composition had a flavor intensity intermediate between gum arabic and starch alone. The sample with the PGA/starch composition had a cleaner orange flavor character than starch alone but less intensity as compared to gum arabic alone.

### Example 3

A co-processed PGA/starch with the same ratio of PGA to starch as the co-processed PGA/starch prepared in Example 1 was prepared using a different starch.

Duck Loid SLF-3 propylene glycol alginate (96.1 g) was added under agitation to deionized water (753.9 g) that had been preheated to 90° C. This solution was stirred for 15 min at 1000 rpm. In a second container, C*EmCap-Instant 126N1 (411.5 g) was added under agitation to deionized water (3708.5 g) that had been preheated to 90° C. The solution was stirred for 15 min at 800 rpm with a three-blade stirrer. The PGA solution was then added to the starch solution and mixed an additional 30 min at 500 rpm. The starch/PGA solution was then homogenized at 2500 psi (176 Kg/cm²).

The viscosity as measured as measured immediately before spray drying using a Brookfield viscometer with #1 spindle at 50 rpm after 30 sec was 34 cps and the slurry pH was 4.5. The mixture was spray dried on a three foot (about 0.91 m) Bowen spray dryer. The inlet dryer temperature was 200° C. and the outlet temperature was 100° C. The final product was spherical in form and the moisture content was about 7.5%. The product was sieved through a 60 mesh screen.

### Example 4

Flavor oil emulsions in Table II were prepared as in Example 2, except that in Examples 4b, 4c, and 4d after the stabilizer was added, the mixture was heated to about 72° C. and mixing continued for about 20 min prior to addition of the remaining ingredients.

TABLE II
Flavor Emulsions^{a}

| Ingredient | 4a | 4b | 4c | 4d |
|---|---|---|---|---|
| Water | 329 | 329 | 333 | 333 |
| Sodium benzoate | 0.4 | 0.4 | 0.4 | 0.4 |
| Example 3^{b} | 28 | 28 | — | — |
| Starch: | | | | |
| Purity 1773 | — | — | 24 | — |
| C*EmCap-Instant 126N1 | — | — | — | 24 |
| Citric acid | 0.8 | 0.8 | 0.8 | 0.8 |
| Yellow dye 6 | 1.75 | 1.75 | 1.75 | 1.75 |
| Flavor oil blend | 40 | 40 | 40 | 40 |

^{a}Amounts given in g.
^{b}The co-processed PGA/starch produced in Example 3.

These flavor emulsions were converted to beverages using the same procedure described in Example 2, except that carbonated water was used instead of filtered water.

The emulsions were placed on storage stability as in Example 2. Emulsion 4c showed signs of separation after about 1.5 weeks at 40° C. The beverage syrup for Example 4c developed a neck ring after three weeks. The remaining samples were acceptable after five weeks.

### Example 5

Two co-processed PGA/starch compositions having a different ratio of PGA to starch were made using the general procedure of Example 3. Viscosity was measured using a Brookfield viscometer. Co-processed PGA/PURITY® Gum 1773 starch was prepared by mixing and spray drying a mixture prepared by adding PURITY® Gum 1773 starch (473.2 g) in deionized water (3,926.8 g) to Duck Loid SLF-3 propylene glycol alginate (67.8 g) in deionized water (532.2 g) as described in Example 3. The viscosity of the slurry before spray drying was 27 cps and the pH was 3.84. Co-processed PGA/C*EmCap-lnstant 126N1 was prepared by mixing and spray drying a mixture prepared by adding C*EmCap-Instant 126N1 starch (487.2 g) in deionized water (3,923.8 g) to Duck Loid SLF-3 propylene glycol alginate (70.6 g) in deionized water (553.7 g) as described in Example 3. The viscosity as measured immediately before spray drying was 32 cps and the pH was 4.46.

The final spray-dried product was spherical in form and the moisture content was less than 10%. The product was sieved through a 60 mesh screen.

### Example 6

This example illustrates use of an extrusion mixer to prepare a high solids co-processed PGA/starch composition.

A premix was prepared by mixing C*EmCap-lnstant 12633 (848 g) and Duck Loid SLF-3 propylene glycol alginate (162.6 g) in a Hobart mixer and adding deionized water (170.8 g) with moderate agitation to give a uniform dough-like consistency. The solids of the premix were 80.2 wt %. The premix was then charged to a Readco laboratory twin shaft mixer, which was operated full open at 100 rpm and 5 to 6 amps. The in-process temperature started at 20° C. and ended at about 50° C. The resulting high solids co-processed PGA/starch had a solids content of 85.9 wt % and a 15:85 weight ratio of PGA/starch. It was ground to a fine powder.

A flavor emulsion prepared using 5 wt % of this high solids co-processed PGA/starch. The flavor emulsion was prepared as in Example 2 using orange oil blend (40 g), the co-processed PGA/starch (20 g), FD&C Yellow Dye 6 (1.75 g), citric acid (0.8 g), sodium benzoate (0.4 g) and deionized water (337.05 g). The dispersion was homogenized with an initial pass at 500 psi (35 Kg/cm²) followed by 4 passes at 3000 psi (211 Kg/cm²). The flavor emulsion had a particle size of 0.66 microns, as measured by a Coulter counter, and remained stable after 3 months storage at room temperature.

### Example 7

This example illustrates use of pulse combustion drying of co-processed starch/PGA solutions.

A sample at 10 wt % solids was prepared by the following method: Distilled water (3809.5 g) was weighed into a deep plastic container. C*EmCap-Instant 12633 (404.41 g) was added steadily and quickly with stirring using a double blade agitator. The sample was mixed for 30 minutes. In a second container, Duck Loid SLF-3 (84.7 gm) was mixed in distilled water (665.4 g) for 30 minutes. The two liquids were then combined and mixed for an additional 30 minutes. The weight ratio was 15:85 PGA/starch. The sample was uniform and free of lumps after mixing.

A total of 6 gallons of material were prepared by this method. Gallon samples were re-mixed, pumped with a peristaltic pump at a feed rate to maintain the desired outlet temperature, and dried using a pulse combustion spray drying system (Pulse Combustion Systems LLC) under the following process conditions:

TABLE III
Co-Processed Starch/PGA Samples using Pulse Combustion Drying

| Sample Number | 1 | 2 | 3 | 4 | 5 | 6 |
|---|---|---|---|---|---|---|
| SETPOINT | | | | | | |
| Contact temp, ° C. | 320.6 | 429.4 | 587.8 | 291.7 | 347.8 | 319.4 |
| Chamber exit temp, ° C. | 93.3 | 99.4 | 98.9 | 98.9 | 101.7 | 104.4 |
| Cyclone temp, ° C. | 85 | 92.2 | 89.4 | 90.6 | 92.8 | 95 |
| DRYER DATA | | | | | | |
| Cyclone recovery, % | 67 | 46 | 71 | 66 | 61 | 57 |
| Total recovery, % | 95 | 82 | 96 | 89 | 86 | 83 |
| POWDER PROPERTIES | | | | | | |
| Moisture, % | 7.0 | 9.0 | 6.5 | 7 | 7.0 | 7.0 |
| Flowability | med | med | med | med | med | med |
| Browning | no | no | no | no | no | no |

Flavor emulsions were prepared for co-processed starch/PGA Samples 1 to 6. Flavor emulsions prepared using Samples 1, 4, 5 and 6 broke to form two even layers. Flavor emulsions prepared using Samples 2 and 3 remained stable and were used to prepare beverage products.

Additional co-processed starch/PGA samples (Samples 7, 8, and 9) were prepared with the same 85:15 starch/PGA composition and dried using pulse combustion drying. Samples 7 and 9 were sprayed at 10 wt % solids and sample 8, which had a decreased amount of water in the formulation, was sprayed at 20 wt % solids. The recovered powders produced stable beverage flavor emulsions and a beverage product that was stable after one month of storage.

TABLE IV
Co-Processed Starch/PGA Samples Prepared by Pulse Combustion
Drying

| | Sample Number | | |
|---|---|---|---|
| | 7 | 8 | 9 |
| Solids content of feed, % | 10 | 20 | 10 |
| SETPOINT | | | |
| Contact temp, ° C. | 418.9 | 461.7 | 553.9 |
| Chamber exit temp, ° C. | 99.4 | 99.4 | 98.9 |
| Cyclone temp, ° C. | 91.1 | 90.6 | 89.4 |
| DRYER DATA | | | |
| Cyclone recovery, % | 65 | 73 | 72 |
| Total recovery, % | 65 | 73 | 72 |
| POWDER PROPERTIES | | | |
| Moisture, % | 7.0 | 7.0 | 7.0 |
| Flowability | med | med | med |
| Browning | no | no | no |

### Example 8

This example illustrates co-processed compositions that were prepared at 20 wt % solids and then roll dried.

C*EmCap-lnstant 12633 (573 g; moisture content was 3.5%) and Duck Loid SLF-3 propylene glycol alginate (110 g; moisture content was 11.4%) were dry blended and this pre-mix was added slowly to deionized water (2567 g) with good agitation. Stirring was continued for an hour with moderate agitation to minimize foaming. The sample was allowed to sit for an hour. A second sample prepared in the same way was de-aerated overnight. These samples were roll dried on a pilot line with 8 in (about 20.3 cm) diameter rolls (steam on the rolls was 168° C.). The dried products were ground to a fine powder. Recovered product was 540 g (79.1% yield) and 575 g (84.2%), respectively.

Flavor emulsions and beverage products were prepared from each roll dried co-processed PGA/starch as described in Example 2. The flavor emulsions were stable. The beverage products prepared from the flavor emulsions were stable after one month of storage.

Having described the invention, we now claim the following and their equivalents.

What is claimed is:

1. A composition comprising co-processed modified starch and propylene glycol alginate, in which:
a) the ratio by weight of modified starch to propylene glycol alginate is 60:40 to 95:5; and
b) the propylene glycol alginate has a degree of esterification of 40% to 95%.

2. The composition of claim 1 in which the modified starch is modified waxy maize starch.

3. The composition of claim 1 or claim 2 in which the degree of esterification is 70% to 95%.

4. The composition of any of claims 1 to 3 in which the propylene glycol alginate has a molecular weight, as defined by viscosity of a 1% aqueous solution measured at 20° C., of 1 to 500 cps.

5. The composition of any of claims 1 to 3 in which the propylene glycol alginate has a molecular weight, as defined by viscosity of a 1% aqueous solution measured at 20° C., of 3 to 60 cps.

6. The composition of any of claims 1 to 3 in which the propylene glycol alginate has a molecular weight, as defined by viscosity of a 1% aqueous solution measured at 20° C., of 3 to 20 cps.

7. The composition of any of claims 1 to 3 in which the propylene glycol alginate has a molecular weight, as defined by viscosity of a 1% aqueous solution measured at 20° C., of 3 to 5 cps.

8. A beverage emulsion comprising a continuous aqueous phase and a discontinuous oil phase, in which the emulsion comprises: 3 to 12% by weight of a stabilizer that comprises at least 80% by weight of the composition of any of claims 1 to 7, and
5% to 15% by weight of the oil phase.

9. The beverage emulsion of claim 8 in which the oil phase comprises flavor oil.

10. The beverage emulsion of claim 8 in which the oil phase comprises a weighting agent.

11. The beverage emulsion of claim 8 in which the oil phase comprises a clouding agent.

12. The beverage emulsion of any of claims 8 to 11 in which the composition comprises at least 85% by weight of the composition of any of claims 1 to 7.

13. The beverage emulsion of any of claims 8 to 11 in which the stabilizer consists essentially of the co-processed composition.

14. A method of preparing the composition of any of claims 1 to 7, the method comprising the steps of:
preparing an essentially uniform aqueous dispersion of the modified starch and the propylene glycol alginate; and
drying the aqueous dispersion and forming the co-processed composition;
in which:
a) the ratio by weight of modified starch to propylene glycol alginate is 60:40 to 95:5; and
b) the propylene glycol alginate has a degree of esterification of 40% to 95%.

15. The method of claim 14 in which the drying is carried out by spray drying.

16. The method of claim 14 in which the drying is carried out by pulse combustion drying.

17. The method of claim 14 in which the drying is carried out by roll drying.

18. A method for preparing the beverage emulsion of any of claims 8 to 13, the method comprising emulsifying a mixture comprising an emulsion stabilizer comprising at least 80% of the composition of any of claims 1 to 7, an oil phase, and water.

19. A syrup for a beverage product, the syrup comprising water; at least one sweetener; and 0.5% by weight to 2.0% by weight of the beverage emulsion of claim 18.

20. The syrup of claim 19 in which the syrup comprises 55% by weight to 60% by weight solids; the sweetener comprises a carbohydrate sweetener; and the solids comprises the sweetener and at least one food grade acid.

21. A beverage product comprising water; at least one sweetener; at least one food grade acid; and 0.05% by weight to 0.7% by weight of the beverage emulsion of any of claims 8 to 13.

22. A composition comprising co-processed modified starch and propylene glycol alginate, in which the propylene glycol alginate has a degree of esterification of 40% to 95%.
